(19) United States
(12) Patent Application Publication
(10) Pub. No.: US 2013/0019533 A1
(43) Pub. Date: Jan. 24, 2013

(54) OVERHEAD DOOR ASSEMBLY WITH COUNTER BALANCE SYSTEM

(71) Applicants: Kenneth Fletcher, Cambridge (CA); Robert Hamilton Hartland, Maple (CA)

(72) Inventors: Kenneth Fletcher, Cambridge (CA); Robert Hamilton Hartland, Maple (CA)

(21) Appl. No.: 13/184,642

(22) Filed: Jul. 18, 2011

(51) Int. Cl. E05F 11/54; E06B 3/52

(52) U.S. Cl. 49/200

(57) ABSTRACT

A counter balance system for an overhead door assembly is provided. The overhead door assembly includes a door frame, an overhead door, and a door lifting assembly. The door lifting assembly includes an extension spring, a cable, and a pulley assembly. The pulley assembly guides the cable as the door is moved between a raised open position and a lowered closed position. A pulley of the pulley assembly is mounted so that an axis of rotation of the pulley remains perpendicular to a portion of the first cable extending between the pulley and a lower portion of the overhead door as the door is moved between the raised open position and the lowered closed position.

### BACKGROUND OF THE INVENTION

The invention relates to overhead doors and, more particularly, to a counter balance system for an overhead door, such as a garage door.

Overhead doors are well-known and are used as closures for openings such as garage and warehouse entrances. The overhead door is configured as a plurality of horizontally oriented, elongated sections hingedly joined along adjacent edges to form the vertical door. The ends of the sections are movably mounted in vertical tracks at each edge of the opening. The upper ends of the tracks curve interiorly to a horizontal position so that when the overhead garage door is opened, it is raised vertically into an elevated, horizontal position inside the enclosure. In this manner, the overhead garage door is suspended overhead and out of the way when it is open to its fullest extent, thereby leaving a relatively unobstructed entrance to the garage, warehouse, or the like.

From the foregoing, it is clear than an overhead garage door of any significant size will be quite heavy to lift vertically from its closed position to the horizontal, open position. Accordingly, it is customary to mount a counterbalancing apparatus or the like to assist the operator in raising and lowering the overhead door between the closed and opened positions. A properly counterbalanced door may be raised and lowered with only a force sufficient to overcome the rolling friction of the rollers attached to the door.

In general, there are two types of counterbalancing assemblies used to aid in lifting overhead sectional doors. The first type of lifting assembly is known as an extension spring system, which commonly involves mounting two extension springs, one on each side of the door, usually just above the horizontal track, perpendicular to the closed overhead door. Each spring is anchored at one end to a bracket, commonly secured to the ceiling of the building structure, while the opposite end of the extension spring is affixed to a movable pulley. A second pulley is fixed proximate the top of the door opening frame. A cable is anchored at one end to a bracket proximate the top of the door opening frame. Its free end passes around the pulleys, extends down the length of the door and is attached at its lower end to the door, typically to the corner bracket. When the door is raised, the two springs contract and each spring pulley pulls up on its cable, which assists with the raising of the door. The extension spring system is advantageous because it uses few parts and is easily installed.

The second type is known as a torsion spring system. It typically involves a single steel shaft mounted to the header of the door opening. One or more torsion springs are slipped over the ends of the shaft and abut a fixed central anchor bracket at their inner ends. The free end of each spring is then connected with a winding plug slipped onto the shaft. A winding rod is used to turn the plug and wind the spring. The plug is then secured to the shaft with set screws. A cable drum is mounted at each end of the shaft. A cable is secured to each drum and extends down to the base of the door, to which it is attached. The door is pulled down to a closed position. When the door is raised, the spring or springs unwind, turning the shaft and causing the cables to roll up on the drums, thereby lifting the door. The torsion spring system is advantageous because mounting the counterbalancing apparatus to the header of the door opening provides for a more reliable, convenient, and aesthetically pleasing mounting location for the counterbalancing apparatus.

Thus, each type of overhead door counterbalancing assembly has particular advantages. Header mounted extension spring counterbalancing systems attempt to obtain the advantages of each. For example, U.S. Pat. No. 5,930,865 to Mihalcheon discloses a header mounted extension spring counterbalancing system having guide pulleys with axes perpendicular to the header, the guide pulleys directing cables downward to mounting points located on the door.

It would be advantageous to develop a counter balance system for an overhead door that provides improved performance while reducing the cost and complexity of the counter balance system.

### SUMMARY OF THE INVENTION

It has been discovered that the known header mounted extension spring counterbalance system has certain disadvantages. Specifically, it has been discovered that the cables in such known systems tend to come free from each of the guide pulleys as the portion of the door the cables are mounted to moves through the curved and horizontal portions of the tracks the door is mounted in, as the cables transition from a vertical position to an oblique or horizontal position. Further, the cables in the oblique position generate thrust forces along an axis of the guide pulley, which can lead to a premature failure of a bearing each of the guide pulleys is mounted on.

To overcome these problems, the invention provides a counter balance system for an overhead door that mounts to a header of a door opening, positions an axis of rotation of a guide pulley perpendicular to a cable extending between the guide pulley and the overhead door, and reduces the cost and complexity of the counter balance system.

In one embodiment, the invention is directed to an overhead door assembly comprising a door frame, an overhead door, and a door lifting assembly. The door frame defines a door opening and the overhead door is movable between a raised open position and a lowered closed position in which the door effectively closes the door opening. The door lifting assembly comprises an extension spring, a first cable, and a first pulley assembly. The extension spring is mounted adjacent the door frame and the first cable interconnects the extension spring and a first lower portion of the overhead door. The first pulley assembly guides the first cable as the door is moved between the raised open position and the lowered closed position. The first pulley assembly comprises a first pulley, wherein the first pulley is mounted so that an axis of rotation of the first pulley remains perpendicular to a portion of the first cable extending between the first pulley and the first lower portion of the overhead door as the door is moved between the raised open position and the lowered closed position.

Various aspects of this invention will become apparent to those skilled in the art from the following detailed description of the preferred embodiment, when read in light of the accompanying drawings.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a perspective view of an overhead door assembly according to an embodiment of the invention, an overhead door of the overhead door assembly shown in a lowered closed position;

FIG. 2 is a perspective of the overhead door assembly shown in FIG. 1, the overhead door of the overhead door assembly shown in a raised open position;

FIG. 3 is a detail view of a first pulley assembly of the overhead door assembly shown in FIG. 1;

FIG. 4 is a detail view of a second pulley assembly of the overhead door assembly shown in FIG. 1;

FIG. 5 is a perspective view of an overhead door assembly according to another embodiment of the invention, an overhead door of the overhead door assembly shown in a lowered closed position;

FIG. 6 is a detail view of a first hinged pulley assembly of the overhead door assembly shown in FIG. 5; and

FIG. 7 is a detail view of a second hinged pulley assembly of the overhead door assembly shown in FIG. 5.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions, directions or other physical characteristics relating to the embodiments disclosed are not to be considered as limiting, unless the claims expressly state otherwise.

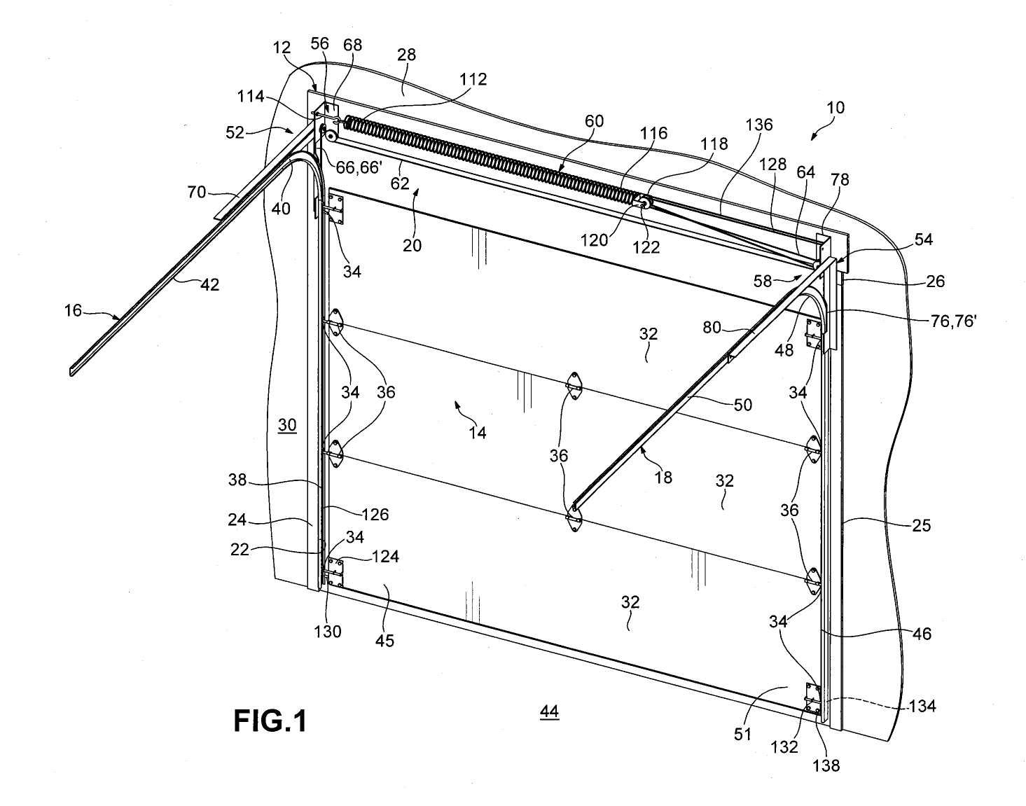

FIG. 1 illustrates an overhead door assembly 10 according to an embodiment of the invention. The overhead door assembly preferably comprises a door frame 12, an overhead door 14, a first door track 16, a second door track 18, and a door lifting assembly 20. As shown, the overhead door assembly 10 is configured for a residential garage door. However, it is understood that the overhead door assembly 10 may be configured for other doors such as overhead doors used in commercial and industrial applications.

The door frame 12 defines a door opening 22. The door frame 12 includes a first side jamb 24, a second side jamb 25, a head jamb 26, and a header 28. The door frame 12 is constructed in a conventional manner as a portion of a wall 30, rigidly securing the header 28 thereto. The door frame 12 is conventional and well known to those skilled in this art.

The overhead door 14 comprises a plurality of door sections 32. Each of the door sections 32 is an elongated panel horizontally oriented and hingedly joined along at least one edge to a door section 32 adjacent thereto to form the overhead door 14. A plurality of door rollers 34 are coupled to the door sections 32 at opposing ends. It is understood that the door rollers 34 may form a portion of a door hinge 36 or that the door rollers 34 may be coupled separate to each door section 32. The overhead door 14 is movable between a raised open position and a lowered closed position. In the lowered closed position, as shown in FIG. 1, the overhead door 14 effectively closes the door opening 22. The overhead door 14 is conventional and well known to those skilled in this art.

The first door track 16 is mounted adjacent the door frame 12. The first door track 16 is formed from a formed metal having a substantially “C” shaped cross-section. The first door track 16 includes a first vertical track portion 38, a first transition portion 40, and a first horizontal track portion 42. A portion of each of the door rollers 34 coupled to each door section 32 adjacent the first door track 16 is disposed in and is in rolling engagement with the first door track 16. The first door track 16 may be unitary or the first door track 16 may be formed from a plurality of track sections. The first door track 16 is conventional and well known to those skilled in this art.

The first vertical track portion 38 is a straight portion of the first door track 16 mounted adjacent and substantially parallel to the first side jamb 24. A first end of the first vertical track portion 38 is positioned adjacent a floor 44 and a first lower portion 45 of the overhead door 14 in the lowered closed position. A second end of the first vertical track portion 38 is positioned adjacent an upper portion of the overhead door 14 in the lowered closed position.

The first transition track portion 40 is an arcuate portion of the first door track 16 mounted adjacent the first side jamb 24. A first end of the first transition track portion 40 tangentially meets the second end of the first vertical track portion 38. A second end of the first transition track portion 40 tangentially meets a first end of the first horizontal track portion 42. The first transition track portion 40 affords the first vertical track portion 38 to be arranged substantially perpendicular to the first horizontal track portion 42.

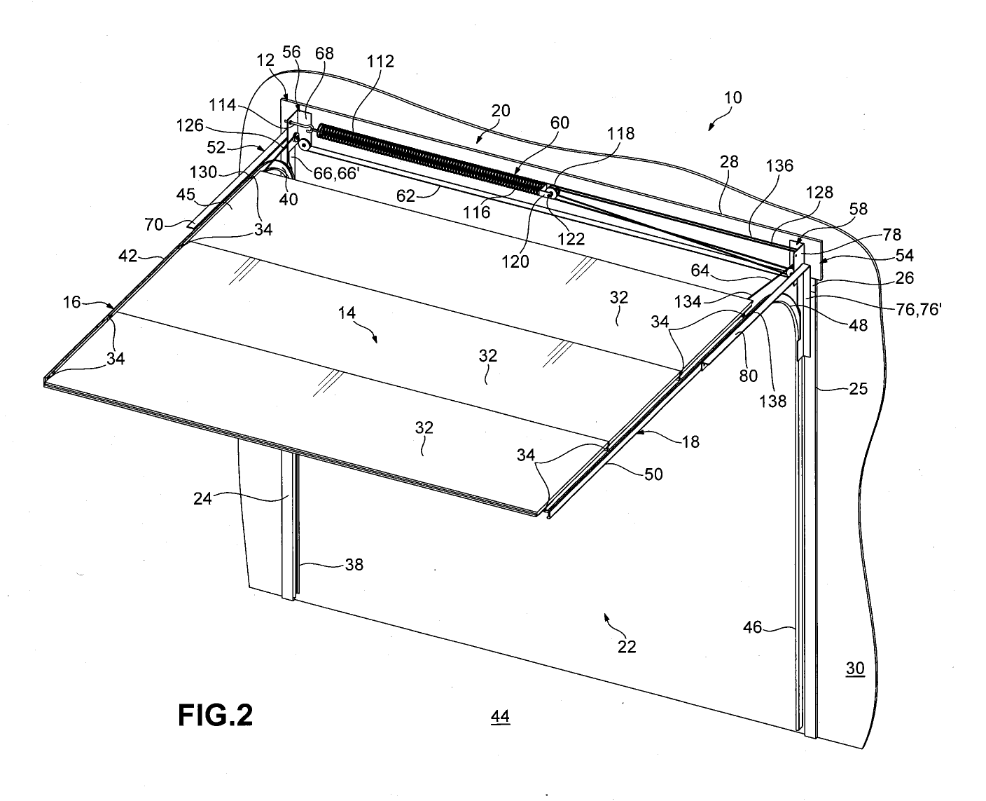

The first horizontal track portion 42 is a straight portion of the first door track 16 mounted substantially perpendicular to the first side jamb 24. A first end of the first horizontal track portion 42 is positioned adjacent the first transition track portion 40 and adjacent the first lower portion 45 of the overhead door 14 in the raised open position, as shown in FIG. 2. A second end of the first horizontal track portion 42 is coupled to a ceiling (not shown) or a support member (not shown).

The second door track 18 is mounted adjacent the door frame 12. The second door track 18 is formed from a formed metal having a substantially “C” shaped cross-section. The second door track 18 includes a second vertical track portion 46, a second transition portion 48, and a second horizontal track portion 50. A portion of each of the door rollers 34 coupled to each door section 32 adjacent the second door track 18 is disposed in and is in rolling engagement with the second door track 18. The second door track 18 may be unitary or the second door track 18 may be formed from a plurality of track sections. The second door track 18 is conventional and well known to those skilled in this art.

The second vertical track portion 46 is a straight portion of the second door track 18 mounted adjacent and substantially parallel to the second side jamb 25. A first end of the second vertical track portion 46 is positioned adjacent the floor 44 and a second lower portion 51 of the overhead door 14 in the lowered closed position. A second end of the second vertical track portion 46 is positioned adjacent an upper portion of the overhead door 14 in the lowered closed position.

The second transition track portion 48 is an arcuate portion of the second door track 18 mounted adjacent the second side jamb 25. A first end of the second transition track portion 48 tangentially meets the second end of the second vertical track portion 46. A second end of the second transition track portion 48 tangentially meets a first end of the second horizontal track portion 50. The second transition track portion 48 affords the second vertical track portion 46 to be arranged substantially perpendicular to the second horizontal track portion 50.

The second horizontal track portion 50 is a straight portion of the second door track 18 mounted substantially perpendicular to the second side jamb 25. A first end of the second horizontal track portion 50 is positioned adjacent the second transition track portion 48 and adjacent the second lower portion 51 of the overhead door 14 in the raised open position, as shown in FIG. 2. A second end of the second horizontal track portion 50 is coupled to a ceiling (not shown) or a support member (not shown).

The door lifting assembly 20 comprises a first bracket assembly 52, a second bracket assembly 54, a first pulley assembly 56, and a second pulley assembly 58, an extension spring 60, a first cable 62, and a second cable 64. The door lifting assembly 20 is mounted adjacent and parallel to the header 28, but it is understood the door lifting assembly 20 may be mounted adjacent and parallel to one of the side jambs 24, 25 or adjacent and parallel to one of the horizontal track portions 42, 50.

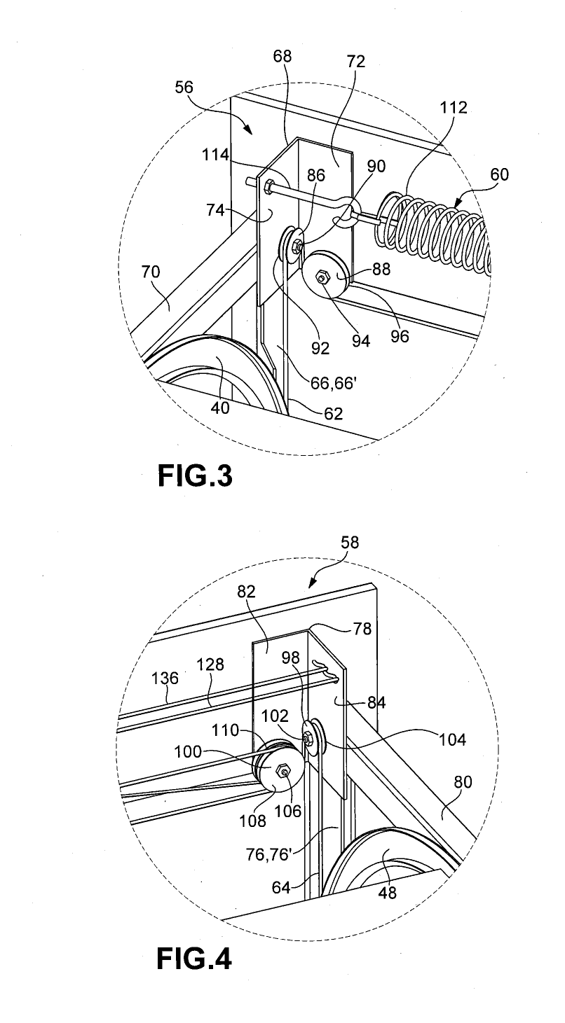

The first bracket assembly 52 comprises a first wall support bracket 66, a first pulley bracket 68, and a first bracing bracket 70. As shown in FIG. 3, the first wall support bracket 66, the first pulley bracket 68, and the first bracing bracket 70 are formed from an angle metal; however, it is understood the first wall support bracket 66, the first pulley bracket 68, and the first bracing bracket 70 may be formed from a plate metal, a box metal, or any other rigid material.

The first wall support bracket 66 is a piece of angle metal coupled to the wall 30 adjacent the header 28 and the first side jamb 24. Alternately, the first wall support bracket 66 may be coupled to the first vertical track portion 38. The first wall support bracket 66 is substantially parallel to the first vertical track portion 38. A plurality of perforations are formed in the first wall support bracket 66 for receiving fasteners for coupling the first wall support bracket 66 to the wall 30, for coupling the first wall support bracket 66 to the first pulley bracket 68, and for coupling the first wall support bracket 66 to the first bracing bracket 70.

The first pulley bracket 68 is a piece of angle metal coupled to the wall 30 adjacent the header 28 and the first wall support bracket 66. Alternately, the first pulley bracket 68 may be coupled only to the first wall support bracket 66. The first pulley bracket 68 is substantially parallel to the first vertical track portion 38. A plurality of perforations are formed in the first pulley bracket 68 for coupling the first pulley bracket 68 to the wall 30, for coupling the first pulley bracket 68 to the first wall support bracket 66, for coupling the extension spring 60 to the first pulley bracket 68, and for mounting the first pulley assembly 56. The first pulley bracket 68 includes a primary portion 72 and a secondary portion 74. The primary portion 72 is substantially parallel to the header 28 and the secondary portion 74 is perpendicular to the primary portion 72.

The first bracing bracket 70 is a piece of perforated angle metal coupled to the first wall support bracket 66 and the first horizontal track portion 42. Alternately, the first bracing bracket 70 may be coupled to the wall 30. The first bracing bracket 70 is substantially parallel to the first horizontal track portion 42. A plurality of perforations are formed in the first bracing bracket 70 for receiving fasteners for coupling the first bracing bracket 70 to the first wall support bracket 66 and for coupling the first bracing bracket 70 to the first horizontal track portion 42.

The second bracket assembly 54 comprises a second wall support bracket 76, a second pulley bracket 78, and a second bracing bracket 80. As shown in FIG. 4, the second wall support bracket 76, the second pulley bracket 78, and the second bracing bracket 80 are formed from an angle metal; however, it is understood the second wall support bracket 76, the second pulley bracket 78 and the second bracing bracket 80 may be formed from a plate metal, a box metal, or any other rigid material.

The second wall support bracket 76 is a piece of angle metal coupled to the wall 30 adjacent the header 28 and the second side jamb 25. Alternately, the second wall support bracket 76 may be coupled to the second vertical track portion 46. The second wall support bracket 76 is substantially parallel to the second vertical track portion 46. A plurality of perforations are formed in the second wall support bracket 76 for receiving fasteners for coupling the second wall support bracket 76 to the wall 30, for coupling the second wall support bracket 76 to the second pulley bracket 78, and for coupling the second wall support bracket 76 to the second bracing bracket 80.

The second pulley bracket 78 is a piece of angle metal coupled to the wall 30 adjacent the header 28 and the second wall support bracket 76. Alternately, the second pulley bracket 78 may be coupled only to the second wall support bracket 76. The second pulley bracket 78 is substantially parallel to the second vertical track portion 46. A plurality of perforations are formed in the second pulley bracket 78 for coupling the second pulley bracket 78 to the wall 30, for coupling the second pulley bracket 78 to the second wall support bracket 76, for coupling the first cable 62 and the second cable 64 to the second pulley bracket 78, and for mounting the second pulley assembly 58. The second pulley bracket 78 includes a primary portion 82 and a secondary portion 84. The primary portion 82 is substantially parallel to the header 28 and the secondary portion 84 is perpendicular to the primary portion 82.

The second bracing bracket 80 is a piece of perforated angle metal coupled to the second wall support bracket 76 and the second horizontal track portion 50. Alternately, the second bracing bracket 80 may be coupled to the wall 30. The second bracing bracket 80 is substantially parallel to the second horizontal track portion 50. A plurality of perforations are formed in the second bracing bracket 80 for receiving fasteners for coupling the second bracing bracket 80 to the second wall support bracket 76 and for coupling the second bracing bracket 80 to the second horizontal track portion 50.

The first pulley assembly 56 guides the first cable 62 as the overhead door 14 is moved between the raised open position and the lowered closed position. The first pulley assembly 56 includes a first pulley 86 and a second pulley 88.

The first pulley 86 is mounted to the secondary portion 74 of the first pulley bracket 68; however, it is understood the first pulley 86 may be mounted to the first wall support bracket 66 or the first bracing bracket 70. A first pulley axis 90 is perpendicular to the secondary portion 74 of the first pulley bracket 68. A width of a first pulley rim 92 is selected based on a diameter of the first cable 62. As shown, the first pulley 86 is mounted centrally on the secondary portion 74, adjacent the first bracing bracket 70; however, it is understood the first pulley 86 may be mounted anywhere on the secondary portion 74.

The second pulley 88 is mounted to the primary portion 72 of the first pulley bracket 68; however, it is understood the second pulley 88 may be mounted to the header 28. A second pulley axis 94 is perpendicular to the primary portion 72 of the first pulley bracket 68. A width of a second pulley rim 96 is selected based on a diameter of the first cable 62. As shown, the second pulley 88 is mounted to a lower portion of the primary portion 72, adjacent the header 28; however, it is understood the second pulley 88 may be mounted anywhere on the primary portion 72 where the second pulley axis 94 is lower than the first pulley axis 90.

The second pulley assembly 58 guides the second cable 64 as the overhead door 14 is moved between the raised open position and the lowered closed position. The second pulley assembly 58 includes a primary pulley 98 and a first double pulley 100.

The primary pulley 98 is mounted to the secondary portion 84 of the second pulley bracket 78; however, it is understood the primary pulley 98 may be mounted to the second wall support bracket 76 or the second bracing bracket 80. A primary pulley axis 102 is perpendicular to the secondary portion 84 of the second pulley bracket 78. A width of a primary pulley rim 104 is selected based on a diameter of the second cable 64. As shown, the primary pulley 98 is mounted centrally on the secondary portion 84, adjacent the second bracing bracket 80; however, it is understood the primary pulley 98 may be mounted anywhere on the secondary portion 84.

The first double pulley 100 is mounted to the primary portion 82 of the second pulley bracket 78; however, it is understood the first double pulley 100 may be mounted to the header 28. A first double pulley axis 106 is perpendicular to the primary portion 82 of the second pulley bracket 78. The first double pulley 100 includes a foremost pulley 108 and a subsequent pulley 110. The foremost pulley 108 and the subsequent pulley 110 may be rotated independently from one another about the first double pulley axis 106. A width of a rim of the foremost pulley 108 and the subsequent pulley 110 is selected based on a diameter of the first cable 62 and the second cable 64, respectively. As shown, the first double pulley 100 is mounted to a lower portion of the primary portion 82, adjacent the header 28; however, it is understood the first double pulley 100 may be mounted anywhere on the primary portion 82 where the first double pulley axis 106 is lower than the primary pulley axis 102.

The extension spring 60 is a coil spring mounted substantially parallel to and adjacent the header 28. The extension spring 60 is conventional and well known to those skilled in this art. A first spring end 112 of the extension spring 60 is coupled to the first pulley bracket 68 using an eye bolt 114; however, it is understood that any conventional fastener may be used and that the extension spring 60 may also be coupled to the first wall support bracket 66, the first bracing bracket 70, or the wall 30. A second spring end 116 of the extension spring 60 is coupled to a spring double pulley 118 using a pulley bracket 120; however, it is understood that any device may be coupled to the second spring end 116 that permits the first cable 62 and the second cable 64 to apply a force to the extension spring 60.

The spring double pulley 118 is mounted to the second spring end 116 with a pulley bracket 120. The spring double pulley 118 is similar to the first double pulley 100; however, the spring double pulley 118 is not fixed and the spring double pulley 118 is free to rotate and translate with respect to a spring double pulley axis 122. Each of a pair of pulleys that comprise the spring double pulley 118 may be rotated independently from one another about the spring double pulley axis 122. A width of a rim of each of the pair of pulleys is selected based on a diameter of the first cable 62 and the second cable 64, respectively.

The first cable 62 is formed from steel strands. The first cable 62 is conventional and well known to those skilled in this art. Alternately, a cable formed from another material may be used. The first cable 62 interconnects a first bottom bracket 124, the first pulley assembly 56, the second pulley assembly 58, the extension spring 60 through the spring double pulley 118, and the second pulley bracket 78. As most clearly shown in FIG. 1, a first end 126 of the first cable 62 is coupled to the first lower portion 45 of the overhead door 14 with the first bottom bracket 124. As shown in FIG. 4, a second end 128 of the first cable 62 is coupled to the second pulley bracket 78 using a fastener.

The first bottom bracket 124 is formed from a sheet metal and is coupled to the first lower portion 45 of the overhead door 14. The first bottom bracket 124 includes one of the door rollers 34 coupled thereto and a first flanged pin 130 extending therefrom a first end 126 of the first cable 62 is coupled to. Alternately, the first end 126 of the first cable 62 may be coupled directly to the overhead door 14.

The second cable 64 is formed from steel strands. The second cable 64 is conventional and well known to those skilled in this art. Alternately, a cable formed from another material may be used. The second cable 64 interconnects a second bottom bracket 132, the second pulley assembly 58, the extension spring 60 through the spring double pulley 118, and the second pulley bracket 78. As most clearly shown in FIG. 1, a first end 134 of the second cable 64 is coupled to the second lower portion 51 of the overhead door 14 with the second bottom bracket 132. As shown in FIG. 4, a second end 136 of the second cable 64 is coupled to the second pulley bracket 78 using a fastener. Alternately, the second end 128 of the first cable 62 and the second end 136 of the second cable 64 may meet at a cable junction (not shown), wherein the cable junction is coupled to the second pulley bracket 78 with a third cable (not shown).

The second bottom bracket 132 is formed from a sheet metal and is coupled to the second lower portion 51 of the overhead door 14. The second bottom bracket 132 includes one of the door rollers 34 coupled thereto and a second flanged pin 138 extending therefrom the first end 134 of the second cable 64 is coupled to. Alternately, the first end 134 of the second cable 64 may be coupled directly to the overhead door 14.

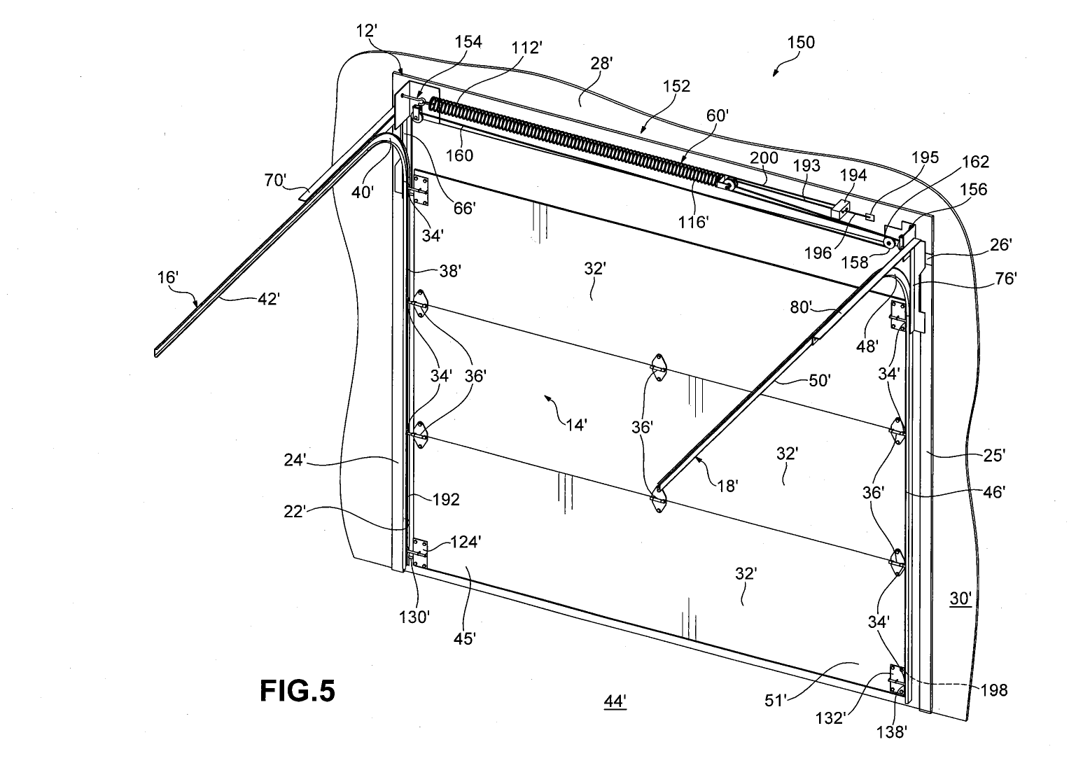

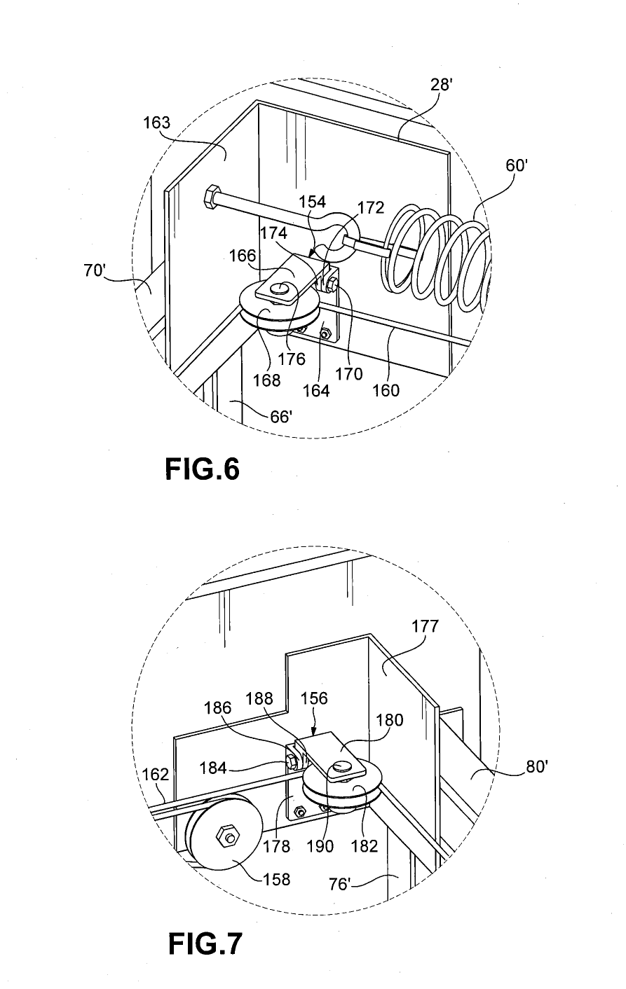

FIGS. 5 and 6 show an alternative embodiment of the overhead door assembly 10. Similar structural features of the overhead door assembly 10 include the same reference numeral and a prime (′) symbol.

FIG. 5 illustrates an overhead door assembly 150 according to an embodiment of the invention. The overhead door assembly preferably comprises a door frame 12′, an overhead door 14′, a first door track 16′, a second door track 18′, and a door lifting assembly 152. As shown, the overhead door assembly 150 is configured for a residential garage door. However, it is understood that the overhead door assembly 150 may be configured for other doors such as overhead doors used in commercial and industrial applications.

The door lifting assembly 152 comprises a first hinged pulley assembly 154, a second hinged pulley assembly 156, a return pulley 158, an extension spring 60′, a first cable 160, and a second cable 162. The first hinged pulley assembly 154, the second hinged pulley assembly 156, the return pulley 158, and the extension spring 60′ are mounted to the header 28′, but it is understood the first hinged pulley assembly 154, the second hinged pulley assembly 156, the return pulley 158, and the extension spring 60′ may be mounted elsewhere.

As most clearly shown in FIG. 6, the first hinged pulley assembly 154 includes a first pulley bracket 163, a first mounting plate 164, a first hinge plate 166, a first hinged pulley 168, and a first pivot pin 170. The first hinged pulley assembly 154 permits the first hinged pulley 168 to rotate about the first pivot pin 170. The first hinged pulley assembly 154 is coupled to the header adjacent the first transition track portion 40′ of the first door track 16′; however, the first hinged pulley assembly 154 may be mounted elsewhere.

The first pulley bracket 163 is a piece of angle metal coupled to the wall 30′ adjacent the header 28′ and the first wall support bracket 66′. Alternately, the first pulley bracket 163 may be coupled only to the first wall support bracket 66′. The first pulley bracket 163 is substantially parallel to the first vertical track portion 38′. A plurality of perforations are formed in the first pulley bracket 163 for coupling the first pulley bracket 163 to the wall 30′, for coupling the first pulley bracket 163 to the first wall support bracket 66′, for coupling the extension spring 60′ to the first pulley bracket 163, and for mounting the first mounting plate 164. The first pulley bracket 163 includes a primary portion and a secondary portion. The primary portion is substantially parallel to the header 28′ and the secondary portion is perpendicular to the primary portion.

The first mounting plate 164 is formed from a steel sheet; however, it is understood that other metals may be used. The first mounting plate 164 includes two pin mounting tabs 172 formed therewith and a plurality of perforations formed therethrough. Each of the pin mounting tabs 172 is substantially perpendicular to the first mounting plate 164 and includes a perforation formed therethrough for receiving the first pivot pin 170. The plurality of perforations formed through the first mounting plate 164 receives fasteners for coupling the first mounting plate 164 to the first pulley bracket 163.

The first hinge plate 166 is formed from a steel sheet; however, it is understood that other metals may be used. The first hinge plate 166 includes two hinge plate tabs 174 formed therewith and a perforation formed therethrough. Each of the hinge plate tabs 174 is substantially perpendicular to the first hinge plate 166 and includes a perforation formed therethrough for mounting the first hinged pulley 168. The perforation formed through the first hinge plate 166 receives a fastener for coupling the first hinged pulley 168 to the first hinge plate 166.

The first hinged pulley 168 is mounted to the first hinge plate 166. A first hinged pulley axis 176 is perpendicular to the first hinge plate 166. As shown, the first hinged pulley 168 is mounted centrally on a lower portion of the first hinge plate 166; however, it is understood the first hinged pulley 168 may be mounted anywhere on the first hinge plate 166.

The first pivot pin 170 is disposed in the pin mounting tabs 172 and the hinge plate tabs 174. As shown in FIG. 6, the first pivot pin 170 defines a substantially horizontal axis. The first hinge plate 166 and the first hinged pulley 168 rotate about the first pivot pin 170. The first pivot pin 170 is secured to the first hinged pulley assembly 154 using any conventional fastener.

As most clearly shown in FIG. 7, the second hinged pulley assembly 156 includes a second pulley bracket 177, a second mounting plate 178, a second hinge plate 180, a second hinged pulley 182, and a second pivot pin 184. The second hinged pulley assembly 156 permits the second hinged pulley 182 to rotate about the second pivot pin 184. The second hinged pulley assembly 156 is coupled to the header 28′ adjacent the second transition track portion 48′ of the second door track 18′; however, the second hinged pulley assembly 156 may be mounted elsewhere.

The second pulley bracket 177 is a piece of angle metal coupled to the wall 30′ adjacent the header 28′ and the second wall support bracket 76′. Alternately, the second pulley bracket 177 may be coupled only to the second wall support bracket 76′. The second pulley bracket 177 is substantially parallel to the second vertical track portion 46′. A plurality of perforations are formed in the second pulley bracket 177 for coupling the second pulley bracket 177 to the wall 30′, for coupling the second pulley bracket 177 to the second wall support bracket 76′, and for mounting the second mounting plate 178. The second pulley bracket 177 includes a primary portion and a secondary portion. The primary portion is substantially parallel to the header 28′ and the secondary portion is perpendicular to the primary portion.

The second mounting plate 178 is formed from a steel sheet; however, it is understood that other metals may be used. The second mounting plate 178 includes two pin mounting tabs 186 formed therewith and a plurality of perforations formed therethrough. Each of the pin mounting tabs 186 is substantially perpendicular to the second mounting plate 178 and includes a perforation formed therethrough for receiving the second pivot pin 184. The plurality of perforations formed through the second mounting plate 178 receives fasteners for coupling the mounting plate 178 to the second pulley bracket 177.

The second hinge plate 180 is formed from a steel sheet; however, it is understood that other metals may be used. The second hinge plate 180 includes two hinge plate tabs 188 formed therewith and a perforation formed therethrough. Each of the hinge plate tabs 188 is substantially perpendicular to the second hinge plate 180 and includes a perforation formed therethrough for mounting the second hinged pulley 182. The perforation formed through the second hinge plate 180 receives a fastener for coupling the second hinged pulley 182 to the second hinge plate 180.

The second hinged pulley 182 is mounted to the second hinge plate 180. A second hinged pulley axis 190 is perpendicular to the second hinge plate 180. As shown, the second hinged pulley 182 is mounted centrally on a lower portion of the second hinge plate 180; however, it is understood the second hinged pulley 182 may be mounted anywhere on the second hinge plate 180.

The second pivot pin 184 is disposed in the pin mounting tabs 186 and the hinge plate tabs 188. As shown in FIG. 7, the second pivot pin 184 defines a substantially horizontal axis. The second hinge plate 180 and the second hinged pulley 182 rotate about the second pivot pin 184. The second pivot pin 184 is secured to the second hinged pulley assembly 156 using any conventional fastener.

The return pulley 158 is mounted to the header 28′ adjacent the second hinged pulley assembly 156; however, it is understood the return pulley 158 may be mounted elsewhere between the extension spring 60′ in an extended state and the second hinged pulley assembly 156. An axis of the return pulley 158 is perpendicular to the header 28′. A width of a return pulley 158 is selected based on a diameter of the first cable 160.

The extension spring 60′ is a coil spring mounted substantially parallel to and adjacent the header 28′. The extension spring 60′ is conventional and well known to those skilled in this art. A first spring end 112′ of the extension spring 60′ is coupled to the first pulley bracket 163 of the first hinged pulley assembly 154; however, it is understood that the extension spring 60′ may coupled elsewhere. A second spring end 116′ of the extension spring 60′ is coupled to a spring double pulley 118′ using a pulley bracket 120′; however, it is understood that any device may be coupled to the second spring end 116′ that permits the first cable 160 and the second cable 162 to apply a force to the extension spring 60′. The first cable 160 is formed from steel strands. The first cable 160 is conventional and well known to those skilled in this art. Alternately, a cable formed from another material may be used. The first cable 160 interconnects a first bottom bracket 124′, the first hinged pulley assembly 154, the return pulley assembly 158, the extension spring 60′ through the spring double pulley 118′, and the header 28′. As most clearly shown in FIG. 5, a first end 192 of the first cable 160 is coupled to the first lower portion 45′ of the overhead door 14′ with the first bottom bracket 124′. A second end 193 of the first cable 160 is coupled to a cable junction 194, wherein the cable junction 194 is coupled to a cable bracket 195 with a third cable 196.

The second cable 162 is formed from steel strands. The second cable 162 is conventional and well known to those skilled in this art. Alternately, a cable formed from another material may be used. The second cable 162 interconnects a second bottom bracket 132′, the second hinged pulley assembly 156, the extension spring 60′ through the spring double pulley 118′, and the header 28′. As most clearly shown in FIG. 5, a first end 198 of the second cable 162 is coupled to the second lower portion 51′ of the overhead door 14′ with the second bottom bracket 132′. A second end 200 of the second cable 162 is coupled to the cable junction 194, wherein the cable junction 194 is coupled to the cable bracket 195 with the third cable 196. Alternately, the third cable 196 or the second end 193 of the first cable 160 and the second end 200 of the second cable 162 may be coupled to the second pulley bracket 177. The cable bracket 195 is mounted to the header using any conventional fastener and includes perforations formed therethrough for receiving the second end 193 of the first cable 160 and the second end 200 of the second cable 162.

In use, the door lifting assemblies 20, 152 guide the first cables 62, 160 and the second cables 64, 162 as the overhead door 14, 14′ is moved between the raised open position and the lowered closed position. The door lifting assemblies 20, 152 include pulleys 86, 168 mounted so that an axis 90, 176 of each of the pulleys 86, 168 remain perpendicular to a portion of the first cables 62, 160 extending between the first pulleys 86, 168 and the first lower portion 45, 45′ of the overhead door 14, 14′ as the overhead door 14, 14′ is moved between the raised open position and the lowered closed position. The door lifting assemblies 20, 152 also include pulleys 98, 182 mounted so that an axis 102, 190 of each of the pulleys 98, 182 remain perpendicular to a portion of the second cables 64, 162 extending between the first pulleys 98, 182 and the second lower portion 51, 51′ of the overhead door 14, 14′ as the overhead door 14, 14′ is moved between the raised open position and the lowered closed position.

As shown in FIG. 1, when the overhead door 14 is in the lowered closed position, the extension spring 60 is in an extended state, storing energy to assist in moving the overhead door 14 to the raised open position (shown in FIG. 2). As the overhead door 14 is moved from the lowered closed position to the raised open position, the extension spring 60 contracts, pulling the first cable 62 and the second cable 64 across the first double pulley 100 and respectively through the first pulley assembly 56 and the primary pulley 98. As most clearly shown in FIG. 4, the first cable 62 and the second cable 64 pass over the first double pulley 100 in opposing directions.

The first cable 62, coupled at the first end 126 to the first bottom bracket 124 applies a lifting force to the overhead door 14. As the overhead door 14 is moved from the lowered closed position to the raised open position, the door roller 34 coupled to the first bottom bracket 124 moves in a vertical direction through the first vertical track portion 38 of the first door track 16. As the door roller 34 coupled to the first bottom bracket 124 moves in the vertical direction, the first cable 62 is substantially vertical and perpendicular to the first pulley axis 90.

As the door roller 34 coupled to the first bottom bracket 124 enters the first transition track portion 40 of the first door track 16, an angle of the portion of the first cable 62 between the first bottom bracket 124 and the first pulley 86 transitions from being substantially vertical to being oblique with respect to the first vertical track portion 38. As the door roller 34 coupled to the first bottom bracket 124 moves through the first transition track portion 40, the first cable 62 remains perpendicular to the first pulley axis 90. Further, where the door roller 34 coupled to the first bottom bracket 124 moves into the first horizontal track portion 42, the first cable 62 remains perpendicular to the first pulley axis 90.

The second cable 64, coupled at the first end 134 to the second bottom bracket 132 applies a lifting force to the overhead door 14. As the overhead door 14 is moved from the lowered closed position to the raised open position, the door roller 34 coupled to the second bottom bracket 132 moves in a vertical direction through the second vertical track portion 46 of the second door track 18. As the door roller 34 coupled to the second bottom bracket 132 moves in the vertical direction, the second cable 64 is substantially vertical and perpendicular to the second pulley axis 94.

As the door roller 34 coupled to the second bottom bracket 132 enters the second transition track portion 48 of the second door track 18, an angle of the portion of the second cable 64 between the second bottom bracket 132 and the second pulley 88 transitions from being substantially vertical to being oblique with respect to the second vertical track portion 46. As the door roller 34 coupled to the second bottom bracket 132 moves through the second transition track portion 48, the second cable 64 remains perpendicular to the second pulley axis 94. Further, where the door roller 34 coupled to the second bottom bracket 132 moves into the second horizontal track portion 50, the second cable 64 remains perpendicular to the second pulley axis 94.

As shown in FIG. 5, when the overhead door 14′ is in the lowered closed position, the extension spring 60′ is in an extended state, storing energy to assist in moving the overhead door 14′ to the raised open position (not shown). As the overhead door 14′ is moved from the lowered closed position to the raised open position, the extension spring 60′ contracts, pulling the first cable 160 across the return pulley 158 and the first hinged pulley 168 and the second cable 162 across second hinged pulley 182.

The first cable 160, coupled at the first end 192 to the first bottom bracket 124′ applies a lifting force to the overhead door 14′. As the overhead door 14′ is moved from the lowered closed position to the raised open position, the door roller 34′ coupled to the first bottom bracket 124′ moves in a vertical direction through the first vertical track portion 38′ of the first door track 16′. As the door roller 34′ coupled to the first bottom bracket 124′ moves in the vertical direction, the first cable 160 is substantially vertical and perpendicular to the first hinged pulley axis 176.

As the door roller 34′ coupled to the first bottom bracket 124′ enters the first transition track portion 40′ of the first door track 16′, an angle of the portion of the first cable 160 between the first bottom bracket 124′ and the first hinged pulley 168 transitions from being substantially vertical to being oblique with respect to the first vertical track portion 38′. Once the portion of the first cable 160 between the first bottom bracket 124′ and the first hinged pulley 168 is oblique with respect to the first vertical track portion 38′, the first cable 160 applies a force along the first hinged pulley axis 176, causing the first hinged pulley 168 and the first hinge plate 166 to rotate about the first pivot pin 170 to match an angle of the first cable 160.

Accordingly, as the door roller 34′ coupled to the first bottom bracket 124′ moves through the first transition track portion 40′, the first cable 160 remains perpendicular to the first hinged pulley axis 176. Further, where the door roller 34′ coupled to the first bottom bracket 124′ moves into the first horizontal track portion 42′, the first cable 160 remains perpendicular to the first hinged pulley axis 176.

The second cable 162, coupled at the first end 198 to the second bottom bracket 132′ applies a lifting force to the overhead door 14′. As the overhead door 14′ is moved from the lowered closed position to the raised open position, the door roller 34′ coupled to the second bottom bracket 132′ moves in a vertical direction through the second vertical track portion 46′ of the second door track 18′. As the door roller 34′ coupled to the second bottom bracket 132′ moves in the vertical direction, the second cable 160 is substantially vertical and perpendicular to the second hinged pulley axis 190.

As the door roller 34′ coupled to the second bottom bracket 132′ enters the second transition track portion 48′ of the second door track 18′, an angle of the portion of the second cable 162 between the second bottom bracket 132′ and the second hinged pulley 182 transitions from being substantially vertical to being oblique with respect to the second vertical track portion 46′. Once the portion of the second cable 162 between the second bottom bracket 132′ and the second hinged pulley 182 is oblique with respect to the second vertical track portion 46′, the second cable 162 applies a force along the second hinged pulley axis 190, causing the second hinged pulley 182 and the second hinge plate 180 to rotate about the second pivot pin 184 to match an angle of the second cable 162.

Accordingly, as the door roller 34′ coupled to the second bottom bracket 132′ moves through the second transition track portion 48′, the second cable 162 remains perpendicular to the second hinged pulley axis 190. Further, where the door roller 34′ coupled to the second bottom bracket 132′ moves into the second horizontal track portion 50′, the second cable 162 remains perpendicular to the second hinged pulley axis 190.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. An overhead door assembly comprising:
a door frame defining a door opening;
an overhead door movable between a raised open position and a lowered closed position in which the door effectively closes the door opening; and
a door lifting assembly comprising:
an extension spring mounted adjacent the door frame;
a first cable interconnecting the extension spring and a first lower portion of the overhead door; and
a first pulley assembly for guiding the first cable as the door is moved between the raised open position and the lowered closed position, the first pulley assembly comprising a first pulley, wherein the first pulley is mounted so that an axis of rotation of the first pulley remains perpendicular to a portion of the first cable extending between the first pulley and the first lower portion of the overhead door as the door is moved between the raised open position and the lowered closed position.

2. The overhead door assembly according to claim 1, wherein the door lifting assembly further comprises a second cable interconnecting the extension spring and a second lower portion of the overhead door, the second lower portion opposite the first lower portion on the overhead door.

3. The overhead door assembly according to claim 2, wherein the door lifting assembly further comprises a second pulley assembly for guiding the second cable as the door is moved between the raised open position and the lowered closed position, the second pulley assembly comprising a second pulley, wherein the second pulley is mounted so that an axis of rotation of the second pulley remains perpendicular to a portion of the second cable extending between the second pulley and the second lower portion of the overhead door as the door is moved between the raised open position and the lowered closed position.

4. The overhead door assembly according to claim 1, wherein the door frame further comprises a header portion.

5. The overhead door assembly according to claim 4, wherein the extension spring is mounted adjacent to and generally parallel with the header portion.

6. The overhead door assembly according to claim 1, wherein the first pulley assembly further comprises a second pulley, the second pulley mounted so that an axis of rotation of the second pulley remains perpendicular to the axis of rotation of the first pulley.

7. The overhead door assembly according to claim 1, wherein the first pulley is a hinged pulley rotatable about a substantially horizontal axis.

8. The overhead door assembly according to claim 1, wherein the overhead door comprises a plurality of hingedly connected sections.

9. The overhead door assembly according to claim 1, wherein the door lifting assembly further comprises a spring pulley coupled to the extension spring, the spring pulley for guiding the first cable as the door is moved between the raised open position and the lowered closed position.

10. The overhead door assembly according to claim 9, wherein the spring pulley is a double pulley.

11. The overhead door assembly according to claim 3, wherein the second pulley assembly further includes a double pulley for guiding the first cable and the second cable, as the door is moved between the raised open position and the lowered closed position.

12. The overhead door assembly according to claim 11, wherein the first cable and the second cable pass over the double pulley in opposing directions.

13. The overhead door assembly according to claim 3, wherein the door lifting assembly further includes a first pulley bracket and a second pulley bracket, the first pulley assembly mounted to the first pulley bracket and the second pulley assembly mounted to the second pulley bracket.

14. The overhead door assembly according to claim 13, wherein the first cable and the second cable are fixed to the second pulley bracket.

15. An overhead door assembly comprising:
a door frame defining a door opening;
an overhead door movable between a raised open position and a lowered closed position in which the door effectively closes the door opening; and
a door lifting assembly comprising:
an extension spring mounted adjacent the door frame;
a first cable interconnecting the extension spring and a first lower portion of the overhead door;
a second cable interconnecting the extension spring and a second lower portion of the overhead door, the second lower portion opposite the first lower portion on the overhead door;
a first pulley assembly for guiding the first cable as the door is moved between the raised open position and the lowered closed position, the first pulley assembly comprising a first pulley; and
a second pulley assembly for guiding the second cable as the door is moved between the raised open position and the lowered closed position, the second pulley assembly comprising a first pulley, wherein the first pulleys of the first pulley assembly and the second pulley assembly are mounted so that the respective axes of rotation of the first pulleys remain perpendicular to a portion of the first cable and a portion of the second cable respectively extending between the first pulley of the first pulley assembly and the first lower portion of the overhead door and the first pulley of the second pulley assembly and the second lower portion of the overhead door as the overhead door is moved between the raised open position and the lowered closed position.

16. The overhead door assembly according to claim 15, wherein the first pulley assembly further comprises a second pulley and the second pulley assembly further comprises a second pulley, the second pulleys of the first pulley assembly and the second pulley assembly mounted so that an axis of rotation of each of the second pulleys remains perpendicular to the axis of rotation of the first pulley.

17. The overhead door assembly according to claim 15, wherein the first pulley of the first pulley assembly and the first pulley of the second pulley assembly are hinged pulleys rotatable about a substantially horizontal axis.

18. The overhead door assembly according to claim 15, wherein the door frame further comprises a header portion which the extension spring is mounted adjacent, the extension spring generally parallel with the header portion.

19. The overhead door assembly according to claim 15, wherein the door lifting assembly further comprises a spring pulley coupled to the extension spring, the spring pulley for guiding the first cable and the second cable as the door is moved between the raised open position and the lowered closed position.

20. An overhead door assembly comprising:
a door frame defining a door opening;
an overhead door movable between a raised open position and a lowered closed position in which the door effectively closes the door opening; and
a door lifting assembly comprising:
an extension spring mounted adjacent the door frame;
a first cable interconnecting the extension spring and a first lower portion of the overhead door;
a second cable interconnecting the extension spring and a second lower portion of the overhead door, the second lower portion opposite the first lower portion on the overhead door;
a first pulley assembly for guiding the first cable as the door is moved between the raised open position and the lowered closed position, the first pulley assembly comprising a first pulley and a second pulley, the second pulley of the first pulley assembly mounted so that an axis of rotation of the second pulley remains perpendicular to an axis of rotation of the first pulley of the first pulley assembly; and
a second pulley assembly for guiding the second cable as the door is moved between the raised open position and the lowered closed position, the second pulley assembly comprising a first pulley and a double pulley, the double pulley of the second pulley assembly mounted so that an axis of rotation of the double pulley remains perpendicular to an axis of rotation of the first pulley of the first pulley assembly, wherein the first cable passes over the first pulley and the second pulley of the first pulley assembly and the double pulley of the second pulley assembly and the second cable passes over the first pulley and the double pulley of the second pulley assembly, the first pulleys of the first pulley assembly and the second pulley assembly mounted so that the respective axes of rotation of the first pulleys remain perpendicular to a portion of the first cable and a portion of the second cable respectively extending between the first pulley of the first pulley assembly and the first lower portion of the overhead door and the first pulley of the second pulley assembly and the second lower portion of the overhead door as the overhead door is moved between the raised open position and the lowered closed position.
